(19) United States
(12) Patent Application Publication
(10) Pub. No.: US 2024/0394205 A1
(43) Pub. Date: Nov. 28, 2024

(54) Intelligence processing unit and its tensor concatenation method

(71) Applicant: SigmaStar Technology Ltd., Xiamen (CN)

(72) Inventors: Hu He, Shanghai (CN); Jian Liu, Shanghai (CN)

(21) Appl. No.: 18/427,853

(22) Filed: Jan. 31, 2024

(30) Foreign Application Priority Data
May 25, 2023 (CN) 202310602205.6

(51) Int. Cl. G06F 13/28

(52) U.S. Cl. CPC G06F 13/28; G06F 2213/28

(57) ABSTRACT

An intelligence processing unit is coupled to an external memory and includes a memory, a direct memory access (DMA) circuit, and a vector accelerator. The external memory stores a first tensor and a second tensor. The DMA circuit performs the following steps: reading a first part of the first tensor from the external memory; storing the first part of the first tensor in the memory; reading a second part of the second tensor from the external memory; and storing the second part of the second tensor in the memory. The vector accelerator includes a register circuit and performs the following steps: storing P bytes of the first part of the first tensor in a target row of the register circuit; storing Q bytes of the second part of the second tensor in the target row of the register circuit; and writing data of the target row into the memory.

This application claims the benefit of China application Serial No. CN202310602205.6, filed on May 25, 2023, the subject matter of which is incorporated herein by reference.

### BACKGROUND OF THE INVENTION

### 1. Field of the Invention

The present invention generally relates to tensor operations of artificial intelligence (AI), and, more particularly, to tensor concatenation methods and intelligence processing units (IPUs).

### 2. Description of Related Art

FIG. 1 shows a schematic diagram of conventional tensor concatenation. The conventional tensor concatenation method concatenates tensors by moving multiple tensors between the memory 110 and the memory 120. More specifically, as shown in FIG. 1, the memory 110 stores 4 tensors to be concatenated (each being a 3-dimensional tensor): the tensor 111 (of shape [100,32,4]), the tensor 112 (of shape [100,32,4]), the tensor 113 (of shape [100,32,1]), and the tensor 114 (of shape [100,32,1]). By writing the tensors into the memory 120 and reading them from the memory 120, the concatenated tensor 115 (of shape [100,32,10]) can be obtained.

Note that in the example of FIG. 1, the axis of the concatenation operation is the innermost dimension of the tensors, and except for the innermost dimension, all other dimensions of the tensors to be concatenated are the same (i.e., [100,32,x], x=1 for the tensor 111 and the tensor 112, and x=4 for the tensor 113 and the tensor 114).

The disadvantage of the conventional tensor concatenation is that when the data transfer between the memory 110 and the memory 120 is performed by a direct memory access (DMA) circuit, it costs the DMA circuit a lot of time to arrange data due to the fact that the data must be read from consecutive memory addresses in the same read operation, and the data must be written to consecutive memory addresses in the same write operation. For example, assuming that the DMA circuit reads 32 bytes of the tensor 111 from the memory 110 in a read operation, when writing the 32 bytes of data to the memory 120, the DMA circuit must perform 8 (=32/4, where 4 is the innermost dimension of the tensor 111, corresponding to columns 1 to 4 of the memory 120) write operations, each writing 4 bytes (because the 4 bytes in each row are consecutive addresses). Note that columns 1 to 4 of the kth row and columns 1 to 4 of the (k+1)^{th} row are not consecutive addresses, k being a positive integer.

Continuing the previous paragraph, similarly, the DMA circuit needs to perform 8 (=32/4, where 4 is the innermost dimension of the tensor 112, corresponding to columns 5 to 8 of the memory 120), 32 (=32/1, where 1 is the innermost dimension of the tensor 113, corresponding to column 9 of the memory 120), and 32 (32 32/1, where 1 is the innermost dimension of the tensor 114, corresponding to column 10 of the memory 120) write operations when writing consecutive 32 bytes of the tensor 112, the tensor 113, and the tensor 114 to the memory 120 respectively. Therefore, the DMA circuit needs to perform 100*32*4/4=3200 times, 100*32*4/4=3200 times, 100*32*1/1=3200 times, and 100*32*1/1=3200 times of write operations to write the tensor 111, the tensor 112, the tensor 113, and the tensor 114 to the memory 120 respectively (a total of 3200*4=12800 write operations are required). Such low tensor concatenation efficiency affects the performance of electronic devices, resulting in poor user experience.

### SUMMARY OF THE INVENTION

According to one aspect of the present invention, an intelligence processing unit (IPU) is provided. The IPU is coupled to an external memory storing a first tensor and a second tensor. The IPU includes a memory, a direct memory access (DMA) circuit, and a vector accelerator. The DMA circuit is coupled to the external memory and the memory and configured to perform the following steps: reading a first part of the first tensor from the external memory; storing the first part of the first tensor in the memory; reading a second part of the second tensor from the external memory; and storing the second part of the second tensor in the memory. The vector accelerator includes a register circuit. The vector is coupled to the memory and configured to perform the following steps: storing P bytes of the first part of the first tensor in a target row of the register circuit, P being a positive integer; storing Q bytes of the second part of the second tensor in the target row of the register circuit, Q being a positive integer; and writing data of the target row into the memory.

According to another aspect of the present invention, a tensor concatenation method is provided. The tensor concatenation method is implemented in an IPU. The IPU is coupled to an external memory and includes a memory and a register circuit. The external memory stores a first tensor and a second tensor. The tensor concatenation method includes the following steps: reading a first part of the first tensor from the external memory; storing the first part of the first tensor in the memory; reading a second part of the second tensor from the external memory; and storing the second part of the second tensor in the memory; and storing P bytes of the first part of the first tensor in a target row of the register circuit, P being a positive integer; storing Q bytes of the second part of the second tensor in the target row of the register circuit, Q being a positive integer; and writing data of the target row into the memory.

The technical means embodied in the embodiments of the present invention can solve at least one of the problems of the prior art. Therefore, compared to the prior art, the present invention can improve the efficiency of tensor concatenation.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows a schematic diagram of conventional tensor concatenation.

FIG. 2 is a functional block diagram of the electronic device according to an embodiment of the present invention.

FIGS. 3A to 3C are flowcharts of the tensor concatenation method according to an embodiment of the present invention.

FIGS. 4A to 4D are schematic diagrams of tensor concatenation according to the present invention.

FIG. 5 is a schematic diagram of using a multi-stage pipeline according to an embodiment of the present invention.

FIG. 6 shows a schematic diagram of a register circuit according to an embodiment of the present invention.

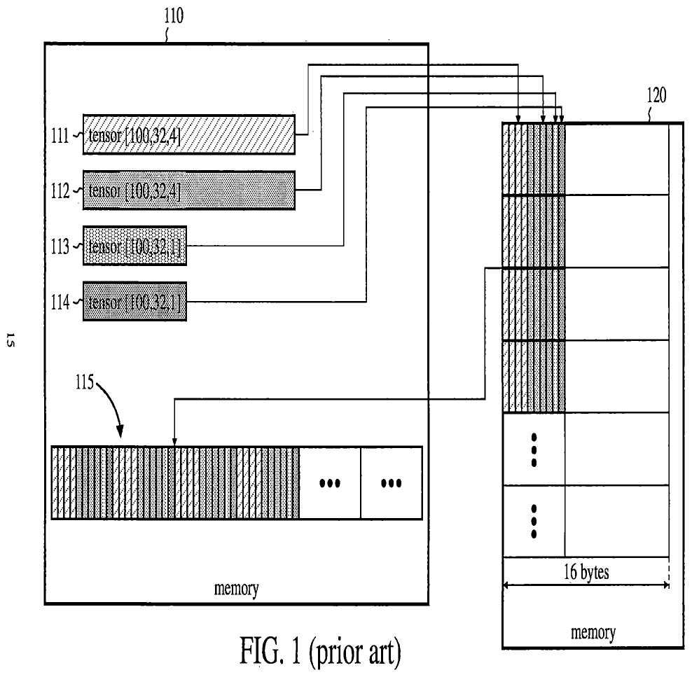

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an intelligence processing unit (IPU) and its tensor concatenation method. On account of that some or all elements of the IPU could be known, the detail of such elements is omitted provided that such detail has little to do with the features of this disclosure, and that this omission nowhere dissatisfies the specification and enablement requirements. Some or all of the processes of the tensor concatenation method may be implemented by software and/or firmware and can be performed by the IPU. A person having ordinary skill in the art can choose components or steps equivalent to those described in this specification to carry out the present invention, which means that the scope of this invention is not limited to the embodiments in the specification.

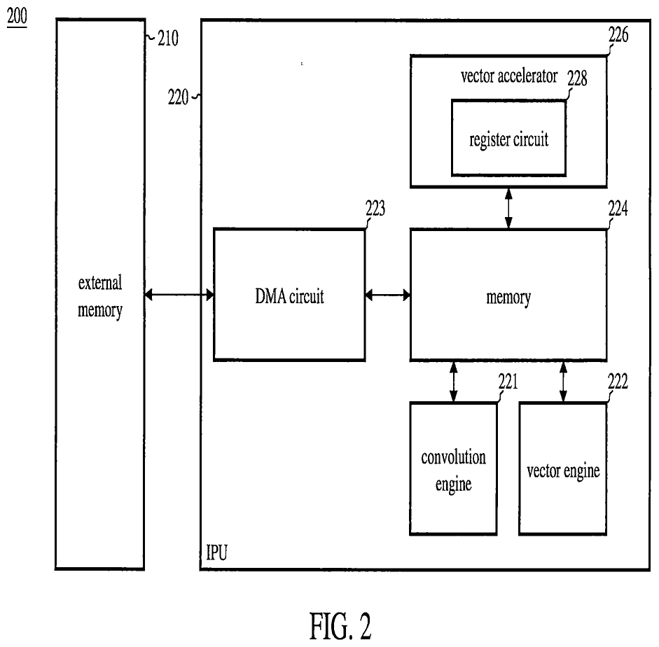

FIG. 2 is a functional block diagram of an electronic device 200 according to an embodiment of the present invention. The electronic device 200 includes an external memory 210 and an IPU 220. The IPU 220 is coupled to the external memory 210 and includes a convolution engine 221, a vector engine 222, a direct memory access (DMA) circuit 223, a memory 224, and a vector accelerator 226. The convolution engine 221 and the vector engine 222 can respectively perform convolution operations and vector operations on tensors. The vector accelerator 226 includes a register circuit 228. The IPU 220 accesses the external memory 210 through the DMA circuit 223. The external memory 210, the memory 224, and the register circuit 228 are all used to store data. In some embodiments, the external memory 210 may be a dynamic random access memory (DRAM), the memory 224 may be a static random access memory (SRAM), and the register circuit 228 may include multiple registers.

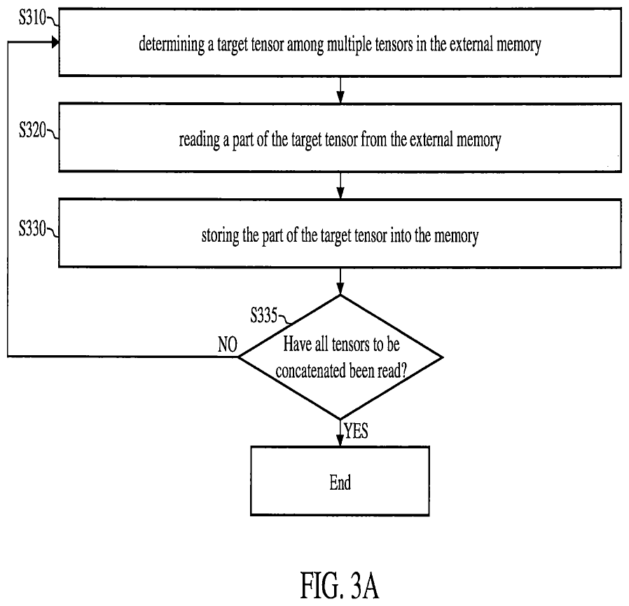

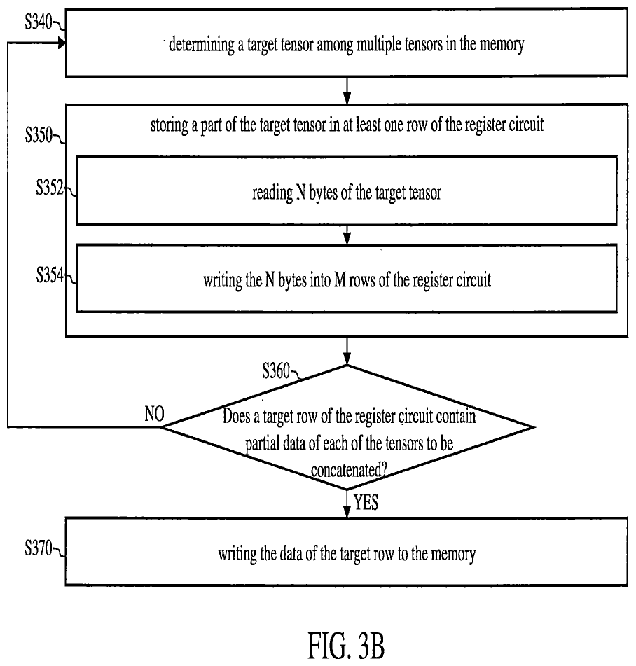

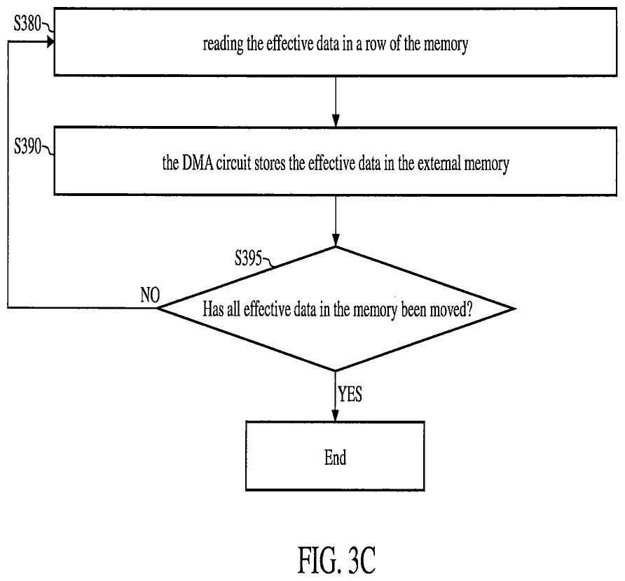

Reference is made to FIGS. 3A to 3C, which are flowcharts of the tensor concatenation method according to an embodiment of the present invention. The steps of FIG. 3A may be performed by the DMA circuit 223. FIG. 3A relates to reading data (i.e., a tensor or a part of a tensor) from the external memory 210 and writing the data to the memory 224. The steps of FIG. 3B may be performed by the vector accelerator 226. FIG. 3B relates to reading data from the memory 224, writing data to the register circuit 228, reading data from the register circuit 228, and writing data to the memory 224. The steps of FIG. 3C may be performed by the DMA circuit 223. FIG. 3C relates to reading data from the memory 224 and writing the data to the external memory 210.

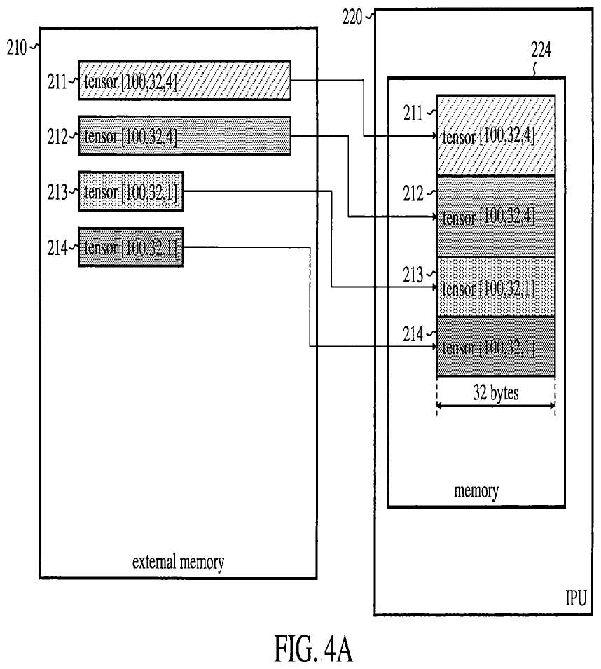

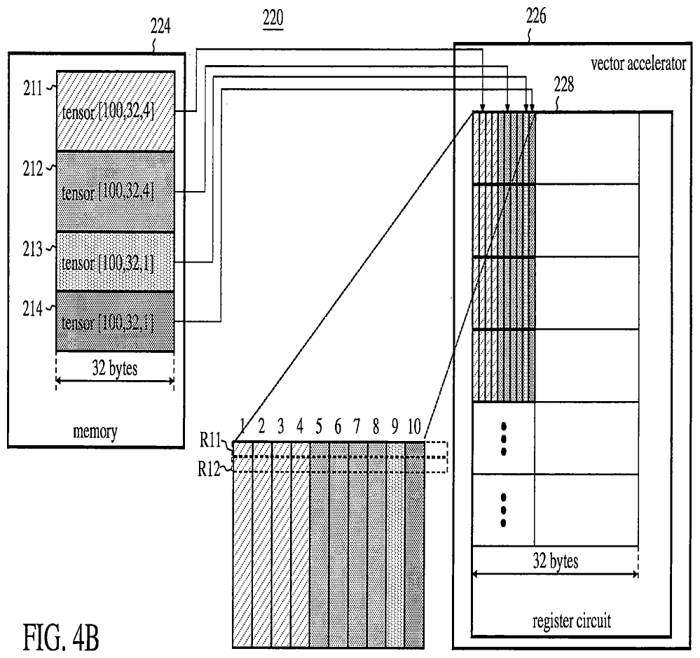

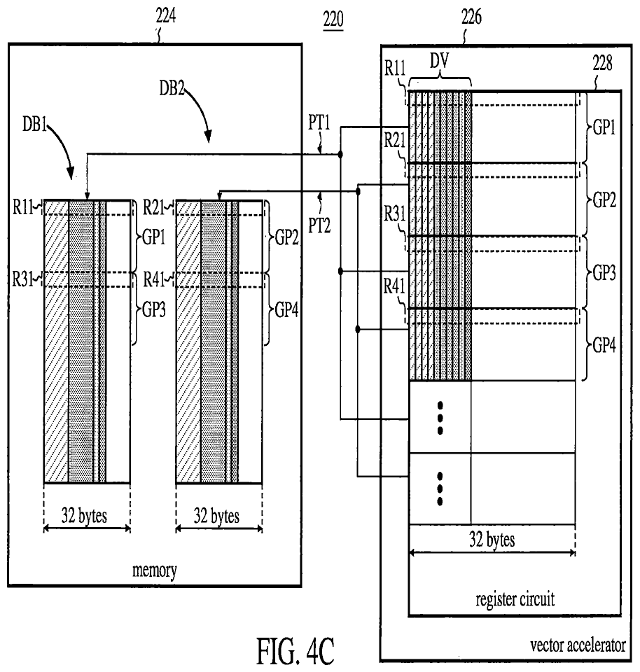

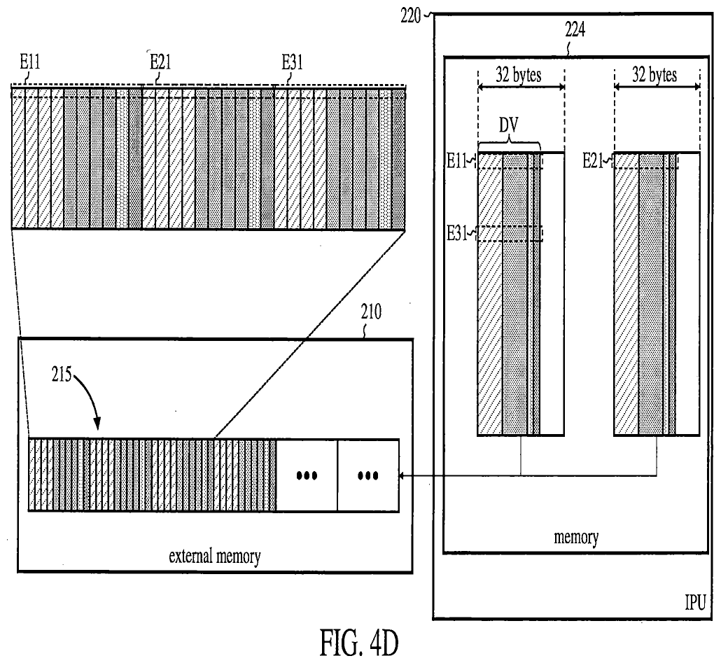

FIGS. 4A to 4D are schematic diagrams of tensor concatenation according to the present invention and correspond to the steps of FIGS. 3A to 3C. Note that in FIGS. 4A to 4D, the amount of data in the memory 224 and the register circuit 228 is for illustrative purposes only. It does not mean that the memory 224 stores all of the data of each of the tensors to be concatenated at the same time, nor does it mean that the register circuit 228 stores all of the data of each of the tensors to be concatenated at the same time.

Reference is made to both FIG. 3A and FIG. 4A for the following discussion. FIG. 3A includes the following steps.

Step S310: The DMA circuit 223 determines a target tensor among multiple tensors in the external memory 210. As shown in FIG. 4A, the external memory 210 stores 4 tensors to be concatenated (each is a 3-dimensional tensor): a tensor 211 (of shape [100,32,4]), a tensor 212 (of shape [100,32,4]), a tensor 213 (of shape [100,32,1]), and a tensor 214 (of shape [100,32,1]). The first 2 dimensions of these 4 tensors ([100,32]) are the same, the third dimensions (i.e., the innermost dimension) are different. In this step, the DMA circuit 223 selects one of the tensor 211, the tensor 212, the tensor 213, and the tensor 214 as a target tensor.

Step S320: The DMA circuit 223 reads a part of the target tensor from the external memory 210. In this step, the DMA circuit 223 reads a first amount of data from consecutive addresses of the external memory 210 in the same one read operation. In some embodiments, the first amount of data may be the bandwidth of the external memory 210 (e.g., 32 bytes).

Step S330: The DMA circuit 223 stores the part of the target tensor into the memory 224. In this step, the DMA circuit 223 writes a second amount of data into consecutive addresses of the memory 224 in the same one write operation. The second amount of data is less than or equal to the operating speed of the IPU 220 (for example, assuming that the IPU 220 processes 16, 32 or 64 bytes of data per unit time, the second amount of data is less than or equal to 16, 32 or 64 bytes). In some embodiments, the first amount of data is equal to the second amount of data; that is to say, the DMA circuit 223 writes the data read in the previous step into the memory 224 in one write operation.

Step S335: The DMA circuit 223 determines whether all tensors to be concatenated have been read. If YES, the flow of FIG. 3A ends; otherwise, steps S310 to S330 are repeated to move more tensors.

In some embodiments, because the memory 224 has limited space (i.e., its capacity is smaller than the capacity of the external memory 210 in order to reduce costs), the memory 224 cannot store all data of all of the tensors to be concatenated at the same time. However, the ratio of the amount of data of the tensors to be concatenated in the memory 224 is equal to the ratio of the innermost dimensions (i.e., the axis of the concatenation operation) of the tensors to be concatenated. For example, because the ratio of the innermost dimensions of the tensor 211, the tensor 212, the tensor 213, and the tensor 214 is 4:4:1:1, the ratio of the amount of data of the tensor 211, the tensor 212, the tensor 213, and the tensor 214 in the memory 224 is also 4:4:1:1. In other words, in some embodiments, the DMA circuit 223 determines the target tensor in step S310 according to the ratio of the dimensions corresponding to the axis of the concatenation operation. For example, the tensor 212 is selected each time the tensor 211 is selected, and the tensor 214 is selected each time the tensor 213 is selected, but the tensor 213 (or the tensor 214) is selected only once every 4 times the tensor 211 (or the tensor 212) is selected.

Reference is made to FIG. 3B, FIG. 4B, and FIG. 4C for the following discussion. FIG. 3B includes the following steps.

Step S340: The vector accelerator 226 determines a target tensor among multiple tensors in the memory 224. Taking FIG. 4B as an example, the vector accelerator 226 selects one of the tensor 211, the tensor 212, the tensor 213, and the tensor 214 as the target tensor.

Step S350: The vector accelerator 226 stores a part of the target tensor in at least one row of the register circuit 228. Step S350 includes sub-step S352 and sub-step S354.

Step S352: The vector accelerator 226 reads N bytes of the target tensor (N is the aforementioned second amount of data). More specifically, the vector accelerator 226 may read N bytes in the same one read operation, and the N bytes may be stored in consecutive addresses of the memory 224.

Step S354: The vector accelerator 226 writes the N bytes into M rows of the register circuit 228. Taking FIG. 4B as an example, for the tensor 211, the N bytes are written into columns 1 to 4 of the register circuit 228, occupying a total of M=N/4 rows (4 is the innermost dimension of the tensor 211). More specifically, the 1st to 4^{th} bytes of the N bytes are respectively written into columns 1 to 4 of the row R11 of the register circuit 228, and the 5th to 8th bytes of the N bytes are respectively written into columns 1 to 4 of the row R12 (which is next to the row R11) of the register circuit 228, . . . , and so on. Similarly, for the tensor 212, the N bytes are written into columns 5 to 8 of the register circuit 228, occupying a total of M=N/4 rows (4 is the innermost dimension of the tensor 212); for the tensor 213, the N bytes are written into column 9 of the register circuit 228, occupying a total of M=N/1 rows (1 is the innermost dimension of the tensor 213); for the tensor 214, the N bytes are written into column 10 of the register circuit 228, occupying a total of M=N/1 rows (1 is the innermost dimension of the tensor 214). In other words, M is equal to N divided by the innermost dimension of the target tensor. In some embodiments, N is a common multiple of the innermost dimensions of all of the tensors to be concatenated.

Step S360: The vector accelerator 226 determines whether a target row of the register circuit 228 contains partial data of each of the tensors to be concatenated. If YES, the vector accelerator 226 performs step S370; otherwise, the vector accelerator 226 performs step S340. Taking FIG. 4B as an example, assuming that the target row is the first row (R11) of the register circuit 228, after the vector accelerator 226 has performed step S340 and step S350 once on each of the tensor 211, the tensor 212, the tensor 213, and the tensor 214, the target row contains partial data of each of the tensors to be concatenated.

Step S370: The vector accelerator 226 writes the data of the target row to the memory 224. Reference is made to FIG. 4C. In this step, the vector accelerator 226 writes the target row (e.g., the row R11, the row R21, the row R31, or the row R41, which may be the first row of the data group GP1, the data group GP2, the data group GP3, and the data group GP4 respectively) to the memory 224. In some embodiments, when the amount of effective data DV of the target row is less than or equal to 1/L times the maximum amount of data (e.g., BW bytes, which may be equal to the aforementioned second amount of data) by which the vector accelerator 226 performs a read operation or write operation on the memory 224, the vector accelerator 226 can use at most L ports simultaneously to move data to save time. The amount of effective data DV of the target row is the number of bytes of the effective data in a row and is equal to the sum of the innermost dimensions of all tensors to be concatenated, which is the innermost dimension of the concatenated tensor. Taking FIG. 4C as an example (assuming BW=32), because L=[BW/DV]=[32/10]=3, the vector accelerator 226 can use at most 3 ports at the same time to move data (in FIG. 4C, 2 ports are illustrated as an example; however, it is also possible to use 3 ports or only 1 port). More specifically, the vector accelerator 226 moves the data of the odd-numbered data groups (the data group GP1, the data group GP3, . . . ) in the register circuit 228 to the data block DB1 in the memory 224 through the port PT1, and move the data of the even-numbered data groups (the data group GP2, the data group GP4, . . . ) in the register circuit 228 to the data block DB2 in the memory 224 through the port PT2. The amount of data of each data group can be the same or different.

In some embodiments, the vector accelerator 226 writes the row R11 and the row R21 to the memory 224 at substantially the same time.

In some embodiments, step S370 may be performed simultaneously with steps S340 to S350. That is to say, the vector accelerator 226 can move the tensors to be concatenated in the memory 224 to the register circuit 228 (FIG. 4B) while moving the concatenated intermediate data (i.e., a part of the concatenated tensor, such as, a data group or a row of a data group) to the memory 224 (FIG. 4C).

Reference is made to both FIG. 3C and FIG. 4D for the following discussion. FIG. 3C includes the following steps.

Step S380: The DMA circuit 223 reads the effective data in a row of the memory 224. For example, in this step, the DMA circuit 223 reads the effective data E11, the effective data E21, or the effective data E31 (which are respectively the amount of effective data DV in the row R11, the row R21, and the row R31).

Step S390: The DMA circuit 223 stores the effective data in the external memory 210. For example, the DMA circuit 223 writes the effective data E11, the effective data E21, or the effective data E31 in the memory 224 to the corresponding location (or address) in the external memory 210 to become a part of the concatenated tensor 215.

Note that the memory 224 also actually stores a part of the concatenated tensor, with the data arrangement in the memory 224 being different from the data arrangement in the external memory 210. In other words, in some embodiments, the convolution engine 221 and/or the vector engine 222 of the IPU 220 can directly read the concatenated data in the memory 224 for subsequent operations.

Step S395: The DMA circuit 223 determines whether all effective data in the memory 224 has been moved to the external memory 210. If YES, the process of FIG. 3C ends; otherwise, the flow returns to step S380.

To sum up, the present invention greatly speeds up tensor concatenation. For example, the conventional method requires a total of 100*32*32=102400 operation cycles to concatenate 32 tensors of the shape [100,32,1] into one tensor of the shape [100,32,32]. In comparison, to concatenate the same tensors, the method of the present invention requires a total of 100*32/32*32+100* (32+16) +100*32=3200+4800+3200 =11200 operation cycles (3200, 4800, and 3200 correspond to FIG. 3A, FIG. 3B, and FIG. 3C respectively). The time required by the conventional method is 102400/11200≈9.14 times that of the present invention.

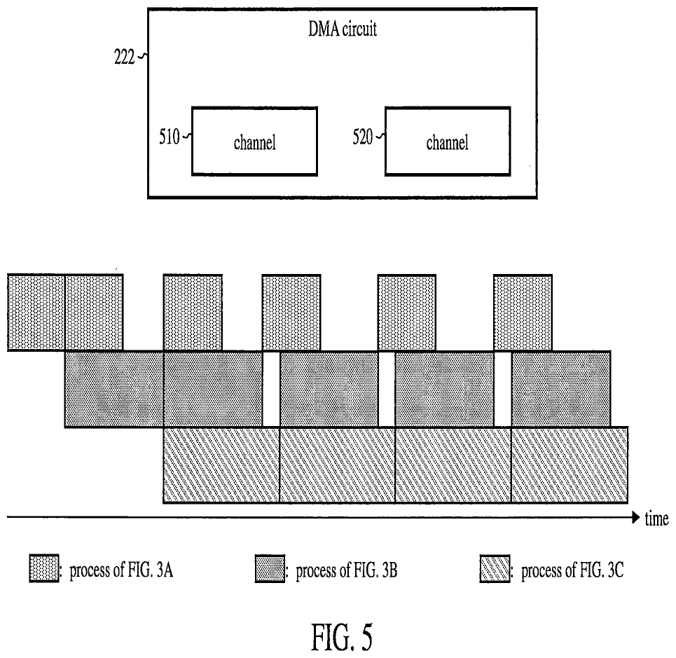

Reference is made to FIG. 5, which is a schematic diagram of using a multi-stage pipeline according to an embodiment of the present invention. In this embodiment, the DMA circuit 223 includes a channel 510 and a channel 520, which are used to perform the process of FIG. 3A and the process of FIG. 3C respectively. In this way, as shown in FIG. 5, the process of FIG. 3A, the process of FIG. 3B, and the process of FIG. 3C can be performed at substantially the same time, improving the tensor concatenation speed of the present invention. Continuing the above example (where 32 tensors of the shape [100,32,1] are to be concatenated), the multi-stage pipeline in FIG. 5 requires only about 4800 operation cycles (corresponding to the total time consumption of the process in FIG. 3B).

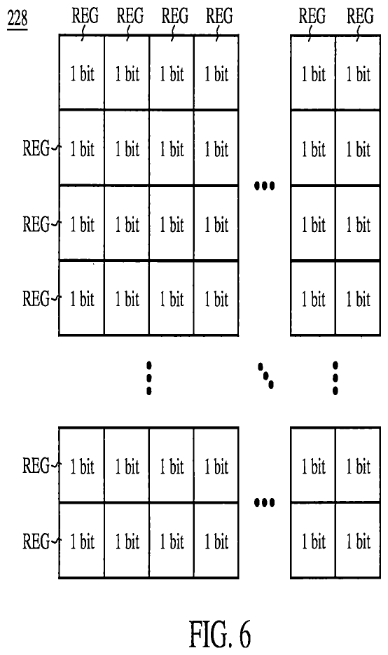

FIG. 6 shows a schematic diagram of the register circuit 228 according to an embodiment of the present invention. The register circuit 228 is a register array including a plurality of registers REG (e.g., each register REG is one bit), and each register REG has its own write line and read line. In this way, the vector accelerator 226 can access any number and any position of the register(s) REG in the register circuit 228 in each operation cycle, which greatly improves the flexibility of read operations and write operations. In comparison, because a row of memory cells in an SRAM shares one write line and one read line, the read and write operations of the SRAM have greater limitations.

The number of tensors to be concatenated (which is 4 in the discussions above) is intended to illustrate the invention by way of example and not to limit the scope of the claimed invention. People having ordinary skill in the art may apply the present invention to 2, 3, or more tensors in accordance with the foregoing discussions.

The axis of the concatenation operation being the innermost dimension of the tensors is intended to illustrate the invention by way of example and not to limit the scope of the claimed invention. People having ordinary skill in the art may apply the present invention to a case where the axis of the concatenation operation is not the innermost dimension of the tensor in accordance with the foregoing discussions.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An intelligence processing unit (IPU) coupled to an external memory storing a first tensor and a second tensor, the IPU comprising:
a memory;
a direct memory access (DMA) circuit coupled to the external memory and the memory and configured to perform following steps:
reading a first part of the first tensor from the external memory;
storing the first part of the first tensor in the memory;
reading a second part of the second tensor from the external memory; and
storing the second part of the second tensor in the memory; and
a vector accelerator that comprises a register circuit, is coupled to the memory, and is configured to perform following steps:
storing P bytes of the first part of the first tensor in a target row of the register circuit, P being a positive integer;
storing Q bytes of the second part of the second tensor in the target row of the register circuit, Q being a positive integer; and
writing data of the target row into the memory.

2. The IPU of claim 1, wherein the target row is a first target row, and the vector accelerator is further configured to perform following steps:
storing R bytes of the first part of the first tensor in a second target row of the register circuit, R being a positive integer;
wherein the second target row is different from the first target row, and P is equal to R.

3. The IPU of claim 2, wherein the second target row is next to the first target row.

4. The IPU of claim 2, wherein storing of the P bytes in the first target row of the register circuit and storing of the R bytes in the second target row of the register circuit are completed in a same one write operation of the vector accelerator.

5. The IPU of claim 2, wherein the vector accelerator is further configured to perform following steps:
storing S bytes of the second part of the second tensor in the second target row of the register circuit, S being equal to Q; and
writing the first target row and the second target row into the memory simultaneously;
wherein the vector accelerator writes at most W bytes in one write operation to the memory, and W is greater than or equal to a sum of P, Q, R, and S.

6. The IPU of claim 1, wherein the innermost dimension of the first tensor is P, and the innermost dimension of the second tensor is Q.

7. The IPU of claim 1, wherein in the memory, a ratio of the first part of the first tensor to the second part of the second tensor is P/Q.

8. The IPU of claim 1, wherein whenever the DMA circuit reads a part of the first tensor P times from the external memory, the DMA circuit reads a part of the second tensor Q times from the external memory.

9. The IPU of claim 1, wherein the DMA circuit further performs following steps:
writing an effective data of the target row into the external memory;
wherein an amount of the effective data is greater than or equal to a sum of P and Q.

10. A tensor concatenation method implemented in an intelligence processing unit (IPU), wherein the IPU is coupled to an external memory and comprises a memory and a register circuit, and the external memory stores a first tensor and a second tensor, the tensor concatenation method comprising:
reading a first part of the first tensor from the external memory;
storing the first part of the first tensor in the memory;
reading a second part of the second tensor from the external memory; and
storing the second part of the second tensor in the memory; and
storing P bytes of the first part of the first tensor in a target row of the register circuit, P being a positive integer;
storing Q bytes of the second part of the second tensor in the target row of the register circuit, Q being a positive integer; and
writing data of the target row into the memory.

11. The tensor concatenation method of claim 10, wherein the target row is a first target row, the tensor concatenation method further comprising:
storing R bytes of the first part of the first tensor in a second target row of the register circuit, R being a positive integer;
wherein the second target row is different from the first target row, and P is equal to R.

12. The tensor concatenation method of claim 11, wherein the second target row is next to the first target row.

13. The tensor concatenation method of claim 11, wherein storing of the P bytes in the first target row of the register circuit and storing of the R bytes in the second target row of the register circuit are completed in a same one write operation.

14. The tensor concatenation method of claim 11 further comprising:
storing S bytes of the second part of the second tensor in the second target row of the register circuit, S being equal to Q; and
writing the first target row and the second target row into the memory simultaneously;
wherein one write operation to the memory writes at most W bytes, and W is greater than or equal to a sum of P, Q, R, and S.

15. The tensor concatenation method of claim 10, wherein the innermost dimension of the first tensor is P, and the innermost dimension of the second tensor is Q.

16. The tensor concatenation method of claim 10, wherein in the memory, a ratio of the first part of the first tensor to the second part of the second tensor is P/Q.

17. The tensor concatenation method of claim 10, wherein whenever the first tensor is read P times from the external memory, the second tensor is read Q times from the external memory.

18. The tensor concatenation method of claim 10 further comprising:
writing an effective data of the target row into the external memory;
wherein an amount of the effective data is greater than or equal to a sum of P and Q.
